(19) United States
(12) Patent Application Publication
(10) Pub. No.: US 2008/0084612 A1
(43) Pub. Date: Apr. 10, 2008

(54) Apparatus for generating a homogeneous angular distribution of laser irradiation

(75) Inventor: Andreas Bayer, Dortmund (DE)

Correspondence Address: LERNER GREENBERG STEMER LLP, P O BOX 2480, HOLLYWOOD, FL, 33022-2480, US

(73) Assignee: Hentze-Lissotschenko Patentverwaltungs GmbH & Co. KG

(21) Appl. No.: 11/810,294

(22) Filed: Jun. 5, 2007

(30) Foreign Application Priority Data
Jun. 10, 2006 (DE) 10 2006 027 095.9

(51) Int. Cl. G02B 27/10

(52) U.S. Cl. 359/623

(57) ABSTRACT

Apparatus for generating a homogeneous angular distribution of laser irradiation (17), the said apparatus comprising a first homogenization stage (10) with a first substrate (1), which includes an entrance face and exit face, wherein a first lens array (4) is disposed on the entrance face and/or on the exit face, through which first lens array the laser irradiation (17) to be homogenized can pass, as well as a second homogenization stage (11) with a second substrate (2), which includes an entrance face and an exit face, wherein a second lens array (5) is disposed on the entrance face and/or on the exit face, through which second lens array the laser irradiation (17) emitted from the first lens array (4) can pass, wherein the laser irradiation (17), after exiting from the second homogenization stage, has a comparably homogeneous angular distribution, wherein the second homogenization stage (11) in addition to the second substrate (2) has a third substrate (3), which includes an entrance face and an exit face, wherein a third lens array (6) is disposed on the entrance face and/or on the exit face, the said third lens array being at a spacing from the second lens array (5), wherein the distance (d₁, d₂) between the second and the third substrate influences the angular distribution.

The present invention relates to an apparatus for generating a homogeneous angular distribution of laser irradiation in accordance with the main preamble of claim 1. In addition, the present invention relates to a plurality of these types of apparatuses.

An apparatus of the aforementioned type is made known in European Patent Application EP 1 489 439 A1. The apparatus described therein comprises two homogenization stages, which are arranged one behind the other in the direction of propagation of the irradiation. Each of these stages, in this case, includes a substrate with a cylindrical lens array on the entrance face and a cylindrical lens array that is crossed relative thereto on the exit face. By means of the two-stage embodiment, the laser irradiation can be homogenized with regard to both its spatial distribution and its angular distribution. Through the use of crossed cylindrical lenses, this can be effected with regard to two independent directions, for example with a laser diode bar as the laser beam source, with regard to the so-called fast axis and the so-called slow axis. The distance between each of the stages corresponds in a substantial manner to the focal length of the second lens array.

A disadvantage of such an apparatus is the fact that, on account of the design of the system, a fixed angular distribution is predetermined on exit from the second lens array. When imaging the said angular distribution into a working plane by means of a condensing lens, the size of a homogeneously illuminated region is predetermined. For example, when generating a homogeneous line through the intermediary of this type of apparatus, the length of the line is predetermined in a predetermined working plane by the design of the apparatus, more especially, by the focal length of the lens arrays.

The problem to which the present invention addresses itself is the creation of an apparatus of the aforementioned type that can be used in a flexible manner.

This is achieved according to the invention through an apparatus of the aforementioned type with the characteristic features of claim 1. In addition, claim 12 specifies a plurality of apparatuses. The sub claims concern preferred developments of the invention.

According to claim 1 it is provided that the second homogenization stage comprises a third substrate in addition to the second substrate, the said third substrate including an entrance face and an exit face, wherein a third lens array is disposed on the entrance face and/or on the exit face, the said third lens array being at a spacing from the second lens array, wherein the distance between the at least one second and the at least one third substrate influences the angular distribution. In this case, it can be provided, for example, that the distance between the second and the third substrate is modifiable, wherein more especially also the distance between the first substrate and the second and/or the third substrate is modifiable. This means that, where required, the apparatus can be modified in such a manner that the angular distribution is modified or respectively the size of the illuminated region in the working plane changes. When, therefore, for example, a homogeneously illuminated line is to be generated in the working plane, its length can be modified by changing the distance between the second and the third substrate. When the distance between the second and the third substrate is modified, it can be sensible to modify the distance between the second and the first substrate at the same time because the at least one first lens array is preferably disposed on the entrance side in the focal plane of the lens system that is formed by the at least one second lens array and the at least one third lens array.

To this end, the apparatus could include positioning means, which can move the second and the third substrate relative to each other, wherein the apparatus, more especially, can also include positioning means which can move the first substrate relative to the second and/or the third substrate. Stepping motors can be used, for example, as positioning means.

In the case of an alternative specific embodiment of the present invention, the three substrates can be disposed on and adhered, corresponding to the requirements in the individual case, for example, to a common base plate. Nevertheless the production is variable because, corresponding to the requirements of the individual case, special apparatuses can be assembled together, it simply being necessary to hold three different substrates in store. By modifying the distances between the substrates, influence can be brought to bear on the angular distribution at the output and consequently also on the size of the illuminated area in the working plane. Consequently, in this case, for example, the producer will have a plurality of apparatuses in accordance with claim 12, where the distance between the at least one second and the at least one third substrate where there are at least two of the plurality of apparatuses differs from one another.

It is possible that the apparatus includes lens means that serve as a condensing lens, through which the laser irradiation can pass after exiting from the at least one third lens array, such that in one working plane a region is generated that is illuminated in a homogeneous manner by the laser irradiation. Through this type of lens means, for example, also with corresponding development of the lens arrays or respectively with corresponding selection of the homogenized laser irradiation, it is possible to generate a homogeneously illuminated line in the working plane.

Further features and advantages of the present invention become clear by way of the following description of preferred exemplified embodiments with reference to the enclosed Figures. In which:

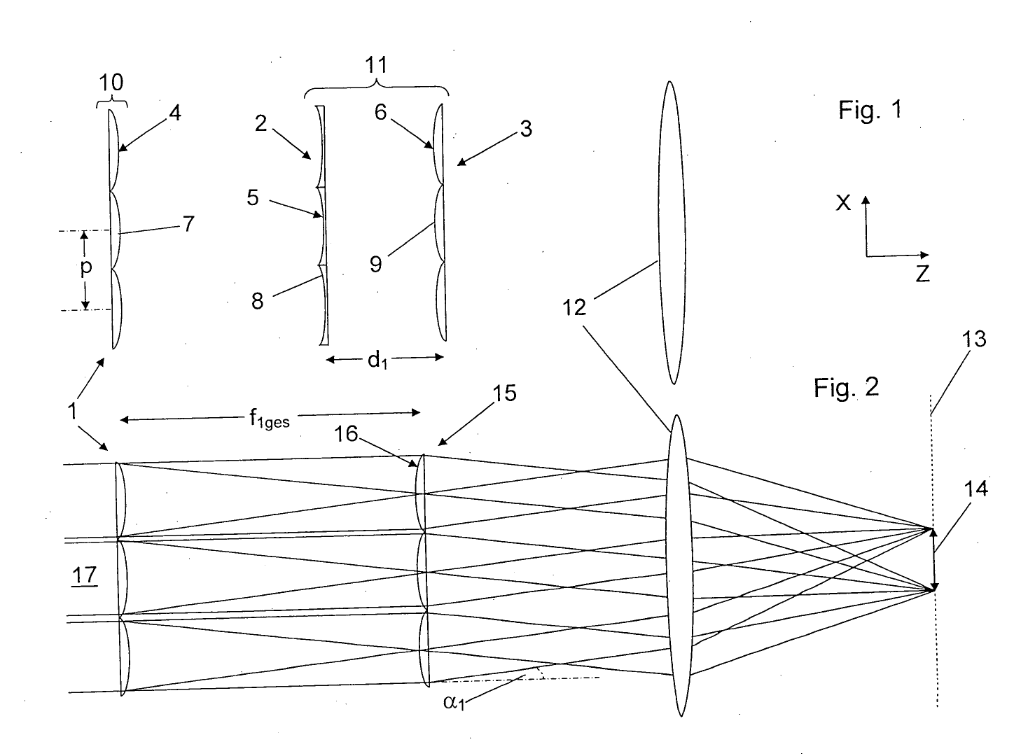

FIG. 1 is a schematic side view of a first specific embodiment of an apparatus according to the invention;

FIG. 2 is a schematic side view of an assumed system, which corresponds to the apparatus in FIG. 1 with regard to its characteristics;

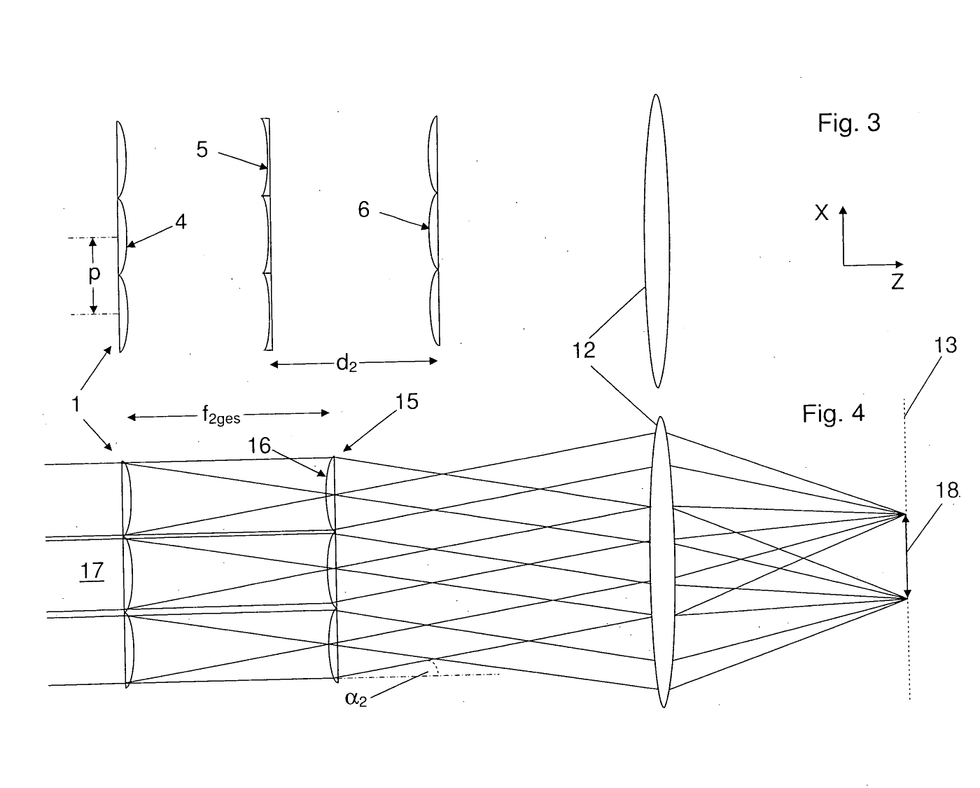

FIG. 3 is a schematic side view of a second specific embodiment of an apparatus according to the invention;

FIG. 4 is a schematic side view of an assumed system, which corresponds to the apparatus in FIG. 3 with regard to its characteristics.

A system of rectangular coordinates is recorded in each of the Figures to improve clarity. Laser irradiation, for example from a semiconductor laser, more especially a laser diode bar, can impinge upon the apparatus according to the invention from the left in the Figures, or respectively in the positive Z direction.

The specific embodiment of an apparatus according to the invention that can 16 be seen in FIG. 1 comprises a first substrate 1, a second substrate 2 and a third substrate 3. The substrates 1, 2, 3, for example, are produced from glass or from another material that is transparent to certain light. Each of the substrates 1, 2, 3 includes an entrance face that is disposed respectively on the left-hand side in FIG. 1 and an exit face that is disposed respectively on the right-hand side for the light that is to be homogenized.

A lens array 4, 5, 6 is disposed respectively on each of the substrates 1, 2, 3. In this case, the first lens array 4 is in the form of an array of convex lenses 7 on the exit side of the substrate 1. The entrance side is not provided with concave or convex structures such that overall an array of plano-convex lenses is produced. Only three lenses 7 are shown in FIG. 1 for reasons of clarity, however, it is completely possible to provide many more lenses 7 than three.

The second lens array 5 is in the form of an array of concave lenses 8 on the entrance side of the substrate 2. The exit side is not provided with concave or convex structures such that overall an array of plano-concave lenses is produced. It is also completely possible in this case also to provide many more lenses 8 than three.

The third lens array 6 is in the form of an array of convex lenses 9 on the entrance side of the substrate 3. The exit side is not provided with concave or convex structures such that overall an array of plano-convex lenses is produced. It is also completely possible in this case to provide many more lenses 9 than three.

The first substrate 1 with the first lens array 4 forms a first homogenization stage 10. A second homogenization stage 11 is formed by the second substrate 2 with the second lens array 5 together with the third substrate 3 or respectively with the third lens array 6.

The lenses 7, 8, 9 are each in the form of cylindrical lenses, the cylindrical axes of which extend in the Y direction. Consequently, the apparatus homogenizes the laser irradiation being propagated in the Z direction only with respect to the X direction. In order to obtain homogenization also with respect to the Y direction, a similarly constructed apparatus with cylindrical lenses, the cylindrical axes of which extend in the X direction, could be disposed behind the apparatus shown. In addition, it is also possible, for example, to dispose the substrates of the apparatuses that work on the X direction and the Y direction in an alternating manner. In addition, it could be provided that cylindrical lenses with cylindrical axes that extend in the X direction are provided on the entrance side of the individual substrates and cylindrical lenses with cylindrical axes extending in the Y direction are provided on the exit side of the individual substrates. Homogenization with respect to the two directions X and Y could also be achieved in this manner.

As an alternative, it is also definitely possible to provide spherical lenses in place of the cylindrical lenses.

In addition, the specific embodiment of an apparatus according to the invention represented in FIG. 1 includes lens means 12 that are in the form of a biconvex condensing lens. The said lens means 12 can be disposed, for example, in such a manner that the exit face of the third substrate 3 is situated in the focal plane of the lens means 12 on the entry side. In a working plane 13 (see FIG. 2), which, for example, is disposed in the focal plane of the lens means 12 on the exit side, there is an illuminated region 14, the size of which depends on the pitch p (see FIG. 1) of the individual lenses 7 of the first lens array 4 in the X direction and on the overall focal length f_{1ges} (see FIG. 2) of the system that is formed by the two lens arrays 5, 6.

To illustrate the invention, FIG. 2 shows a system which corresponds to the apparatus in FIG. 1 with regard to its functioning. The two substrates 2, 3 with the lens arrays 5, 6 have been replaced by one single substrate 15 with a lens array 16. In this case, the focal length f_{ges} of the lens array 16 corresponds to the focal length of the system formed by the second and the third lens array 5, 6. For thin lenses and a small distance between the lenses, the system focal length f_{ges} is produced approximately by means of the known formula 1/f_{1ges}=1/f₈+1/f₉−d₁/(f₈*f₉), wherein d₁ is the distance between the lens arrays 5, 6 (see FIG. 1) and wherein f₈ is the focal length of the lenses 8 as well as f₉ is the focal length of the lenses 9. More especially, the first lens array 4 is disposed on the entrance side in the focal plane of the system that is made up by the second lens array 5 and the third lens array 6. This is also illustrated in FIG. 2, in which the distance f_{1ges} between the “system lens array” 16 and the first lens array 4 can be seen.

The alternative system given in FIG. 2 also illustrates the homogenization of the incident laser irradiation 17. More especially, an illuminated region 14, which, for example, is linear, is produced in the working plane 13. The expansion of the said illuminated region in the X direction is dependent on the angle α₁ between the light leaving the second homogenization stage 11 and 24 the Z direction (see FIG. 2). The said angle α₁, in its turn, is dependent on the pitch p and the overall focal length f_{ges} of the system made up by the second lens array 5 and the third lens array 6.

FIG. 3 shows a second specific embodiment of an apparatus according to the invention, where identical parts are provided with references that are identical to those used in FIGS. 1 and 2. The apparatus in FIG. 3 differs from that in FIG. 1 simply by the distance d₂ between the second lens array 5 and the third lens array 6 (see FIG. 3), which is greater than the distance d₁ in the case of the apparatus in FIG. 1, and by the distance between the second lens array 5 and the first lens array 4. The said distance has been adapted corresponding to the changed system focal length f_{2ges} (see FIG. 4) such that, in addition, the first lens array 4 is disposed on the entrance side in the focal plane of the system made up of the second lens array 5 and the third lens array 6.

On account of the changed system focal length f_{2ges}, the angle α₂ between the light leaving the second homogenization stage 11 and the Z direction also changes (see FIG. 4). As f_{2ges} in the case of the apparatus in FIG. 3 or respectively FIG. 4 is smaller than f_{1ges} in the case of the apparatus in FIG. 1 or respectively FIG. 2, the angle α₂ is greater than the angle α₁. Consequently, however, the illuminated region 18 in the working plane 13 of the apparatus in FIG. 3 or respectively FIG. 4 in the X direction is greater than that of the apparatus in FIG. 1 or respectively FIG. 2. By changing the distance between the second lens array 5 and the third lens array 6 and adapting the distance between the second lens array 5 and the first lens array. 4 in a corresponding manner, it is possible to influence the size of the illuminated region in the working plane.

1-12. (canceled)

13. An apparatus for generating a homogeneous angular distribution of laser radiation, the apparatus comprising
a first homogenization stage with a first substrate having an entrance face and an exit face;
a first lens array disposed on at least one of said entrance face and said exit face and configured to enable laser radiation to be homogenized to pass therethrough;
a second homogenization stage with a second substrate and a third substrate, each of said first and second substrates having an entrance face and an exit face;
a second lens array disposed on at least one of said entrance face and said exit face of said second substrate for laser radiation emitted from said first lens array to pass therethrough;
a third lens array disposed on at least one of said entrance face and said exit face of said third substrate at a spacing distance from said second lens array; and
wherein the laser radiation, after exiting from said second homogenization stage, has a comparably homogeneous angular distribution, and the spacing distance (d₁, d₂) between said second and third substrates influences the angular distribution of the laser radiation.

14. The apparatus according to claim 13, wherein said first lens array is disposed on an entrance side in a focal plane of a lens system formed from said second lens array and said third lens array.

15. The apparatus according to claim 13, wherein a distance (d₁, d₂) between said second and third substrates is variable.

16. The apparatus according to claim 15, wherein a distance between said first substrate and at least one of said second and third substrates is variable.

17. The apparatus according to claim 16, which comprises positioning means configured to move said second and third substrates relative to one another, and positioning means for moving said first substrate relative to at least one of said second and third substrates.

18. The apparatus according to claim 15, which comprises positioning means configured to move said second and third substrates relative to one another.

19. The apparatus according to claim 13, which comprises lens means acting as a condensing lens, disposed for the laser irradiation to pass through after exiting said at least one third lens array, for generating substantially homogeneous laser illumination in a region of a working plane.

20. The apparatus according to claim 13, wherein each said lens array includes a plurality of spherical lenses.

21. The apparatus according to claim 13, wherein each said lens array includes a plurality of cylindrical lenses.

22. The apparatus according to claim 21, wherein said cylindrical lenses are orientated with mutually parallel cylindrical axes.

23. The apparatus according to claim 21, wherein said substrates each include a plurality of cylindrical lenses on the respective said entrance face and said exit face, wherein cylindrical axes of said cylindrical lenses disposed on the respective said entrance face and the respective said exit face are orientated at right angles to each other.

24. The apparatus according to claim 19, wherein said first substrate is one of two first substrates with two first lens arrays, said second substrate is one of two second substrates with two second lens arrays and said third substrate is one of two third substrates with two third lens arrays.

25. The apparatus according to claim 24, wherein cylindrical axes of said first lens arrays are disposed at rights angles to each other and/or cylindrical axes of said second lens arrays are disposed at right angles to each other and/or cylindrical axis of said third lens arrays are disposed at right angles to each other.

26. A laser assembly, comprises a plurality of apparatuses according to claim 13, wherein a distance (d₁, d₂) between said at least one second and said at least one third substrate, between at least two of said plurality of apparatuses, differ from each other.
